(19) United States
(12) Patent Application Publication
(10) Pub. No.: US 2015/0242961 A1
(43) Pub. Date: Aug. 27, 2015

(54) ENRICHED FINANCIAL TRANSACTION RECORDS

(71) Applicant: SRI International, Menlo Park, CA (US)

(72) Inventors: Sasha Caskey, New York, NY (US); Zor Gorelov, North Cardwell, NJ (US); Dror Oren, Mountain View, CA (US); William Mark, San Mateo, CA (US)

(73) Assignee: SRI International, Menlo Park, CA (US)

(21) Appl. No.: 14/189,530

(22) Filed: Feb. 25, 2014

(51) Int. Cl. G06Q 40/00

(52) U.S. Cl. CPC G06Q 40/12

(57) ABSTRACT

Example systems and methods of providing enriched financial transaction records are described. In one implementation, a method identifies a financial transaction record that describes a financial transaction associated with a financial institution. The method accesses metadata that has a relationship to the financial transaction and is not structured as a financial transaction record. The metadata is associated with the financial transaction record.

### TECHNICAL FIELD

The present disclosure relates to systems and methods that enrich financial transaction records.

### BACKGROUND

Financial transaction records currently provided by financial institutions contain minimal information about the transaction. Some existing financial institutions offer basic information about the transaction to a user, such as date, transaction amount, and merchant contact information. In some situations, the data provided for multiple transactions is inconsistent (e.g., the financial transaction data provided to the user may vary depending on the particular merchant or other factors). This lack of data, and presentation of inconsistent data, provides the user with minimal useful information. Further, the user must manually review the financial transaction records to identify desired information. This approach is tedious and time-consuming for the user.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an environment within which an example embodiment may be implemented.

FIG. 2 is a block diagram depicting an embodiment of a transaction enrichment module.

FIG. 3 is a flow diagram depicting an embodiment of a method for associating metadata with a financial transaction.

FIG. 4 is a flow diagram depicting an embodiment of a method for processing a user query for a particular financial transaction.

FIG. 5 is a flow diagram depicting an embodiment of a method for processing a user query for a group of financial transactions.

FIG. 6 is a flow diagram depicting an embodiment of a method for geographic clustering of multiple financial transactions.

FIG. 7 is a block diagram depicting an embodiment of a social media processing module.

FIG. 8 is a block diagram depicting an embodiment of a calendar processing module.

FIG. 9 is a block diagram depicting an embodiment of an email processing module.

FIG. 10 is a block diagram depicting an embodiment of a web data processing module.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The systems and methods described herein provide enriched financial transaction records by augmenting the records with information from one or more data sources, including internal and/or external data sources. As discussed herein, the enriched financial transaction records contain more information than traditional financial transaction records, such as merchant contact information, merchant URL (uniform resource locator), merchant address, and metadata that groups together multiple records (e.g., “food expenses,” “trip to Las Vegas” or “soccer events”). The described systems and methods associate the additional information and metadata with the financial transactions, then use that information and metadata to automatically identify related transactions. In some embodiments, users can query the system using a natural language query to identify one or more desired transactions without manually searching through a long list of financial transaction records.

In some embodiments, the systems and methods described herein automatically associate transaction data with data from external sources (e.g., accessible via the Internet or other data communication systems). The financial transaction records are augmented with the data from external sources. The data from the external sources may be stored in any number of different data formats, one or more of which are different from the data format of the financial transaction records. For example, data from non-financial data sources is not typically structured as a financial transaction record. Thus, the described systems and methods are capable of associating many types of data represented in various data formats to generate “enriched financial transaction records.” After associating data from external sources with the financial transaction records, the systems and methods can group the financial transactions in different ways. These groups of financial transactions may be referred to as “transaction groups.” In some embodiments, groups of financial transactions are based on events related to the user, such as business trips, vacations, entertainment events, sporting events, and the like. In other embodiments, the groups of financial transactions are based on particular merchants, types of merchants, geographic location of the transaction, and so forth.

In some embodiments, the enriched financial transaction records are searched using a natural language-based user interface that allows a user to submit queries in a spoken natural language. For example, a user may ask “how much did I spend on entertainment last night” or “show me my transactions from my trip to Las Vegas last month.” The described systems and methods access the enriched financial transaction records to identify the specific transactions associated with the user's query and generate a response to the user's query.

The enriched financial transaction records may be further enriched over time. For example, systems and methods may further modify the enriched financial transaction records with additional external data or with updated data. Additionally, a user may choose to export the enriched financial transaction records from a financial institution to the user's personal computing system. After exporting the enriched financial transaction records, the user may choose to further enrich the records using additional personal information accessible to the user's personal computing system. This allows the user to further enrich the financial transaction records without exposing the additional personal information to the financial institution or other systems. In other embodiments, users may share a portion of their enriched financial transaction records with other users, such as friends or family members. For example, if multiple users are sharing travel expenses, one user may share their enriched financial transaction records associated with the travel with the other users for purposes of determining the total travel cost.

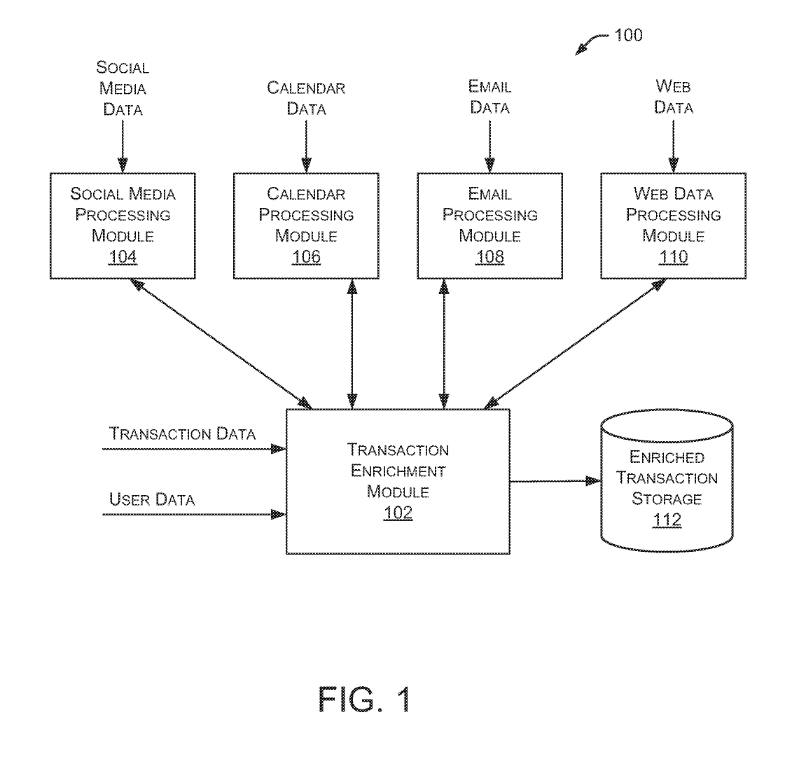

FIG. 1 is a block diagram depicting an environment 100 within which an example embodiment may be implemented. Environment 100 includes a transaction enrichment module 102 coupled to a social media processing module 104, a calendar processing module 106, an email processing module 108, and a web data processing module 110. Additionally, transaction enrichment module 102 is coupled to receive transaction data and user data from one or more data sources. For example, the transaction data and/or user data may be received from financial institutions, payment processors, financial data sources, user data sources, and the like. Transaction enrichment module 102 is also coupled to an enriched transaction storage device 112, which stores transaction data, user data, and other data used during the operation of transaction enrichment module 102.

Social media processing module 104 receives social media data from various data sources, including any number of different social media services. As discussed herein, social media processing module 104 processes events and identifies data associated with social media activities, such as dates and topics of discussion. Calendar processing module 106 identifies events from the received calendar data as well as dates, topics, locations, and people associated with the events. Email processing module 108 receives email data from one or more data sources and extracts events, topics, dates, user identities, and the like from the email data. Web data processing module 110 receives web data from one or more data sources and identifies information contained in the web data. Example web data includes information related to merchant contact information, merchant web site URLs, merchant transactions, merchant location, event dates, event times, event locations, and the like.

Transaction enrichment module 102 receives data from social media processing module 104, calendar processing module 106, email processing module 108, and web data processing module 110. This data is aggregated with transaction data and user data to create enriched financial transaction records, as discussed herein.

Although four modules 104, 106, 108, and 110 are shown in FIG. 1 that access data from external data sources, alternate embodiments may include any number of modules configured to access data from any number of data sources.

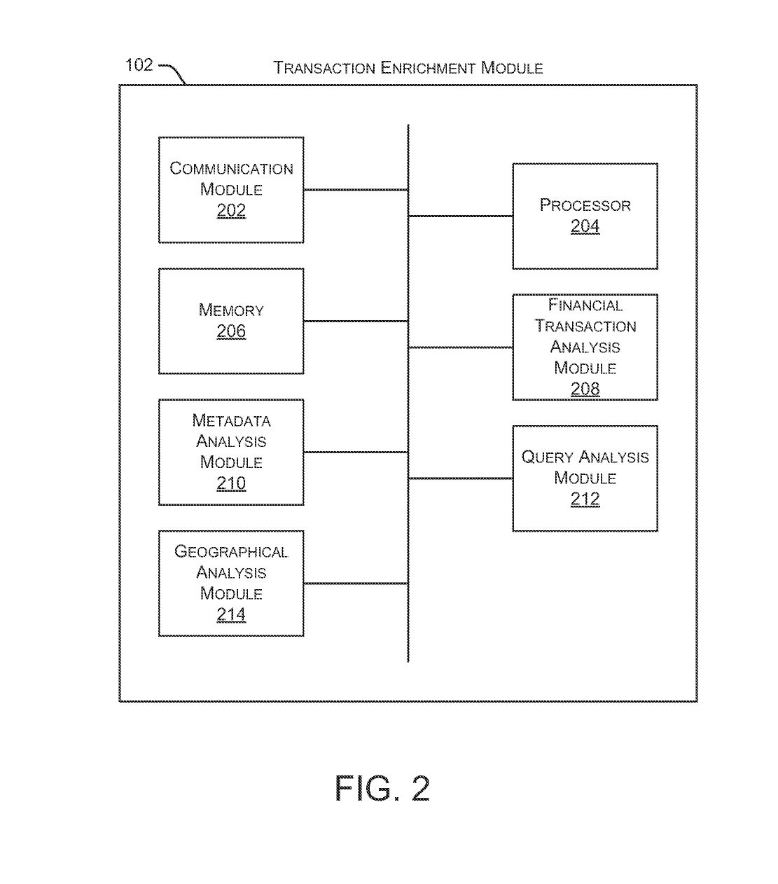

FIG. 2 is a block diagram depicting an embodiment of a transaction enrichment module 102. Transaction enrichment module 102 includes a communication module 202, a processor 204, and a memory 206. Communication module 202 allows transaction enrichment module 102 to communicate with other systems, such as modules 104, 106, 108, and 110, financial institutions, external data sources, and the like. Processor 204 executes various instructions to implement the functionality provided by transaction enrichment module 102. Memory 206 stores these instructions as well as other data used by processor 204 and other modules contained in transaction enrichment module 102.

Transaction enrichment module 102 also includes a financial transaction analysis module 208, which analyzes financial transaction data to identify details associated with specific transactions. A metadata analysis module 210 analyzes various metadata received from any number of data sources and associates the metadata with one or more financial transactions. A query analysis module 212 analyzes a user queries to determine the specific transaction or group of transactions being requested by the user. A geographical analysis module 214 identifies geographic locations associated with financial transactions, merchants, calendar events, and the like.

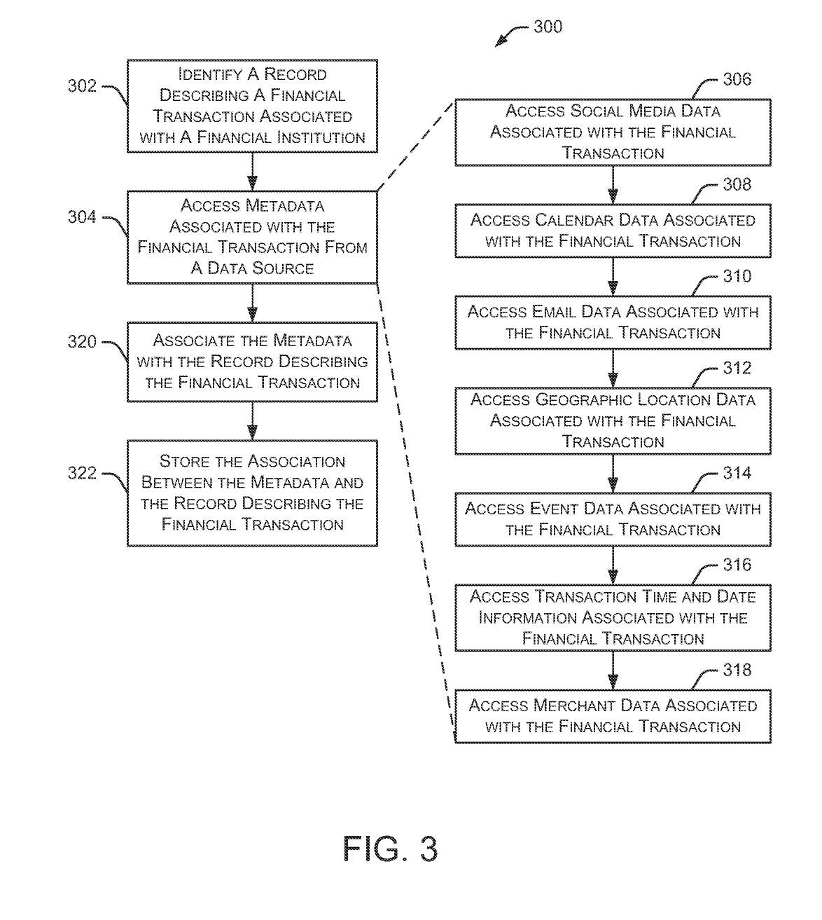

FIG. 3 is a flow diagram depicting an embodiment of a method 300 for associating metadata with a financial transaction. In particular implementations, method 300 is performed by transaction enrichment module 102 (FIG. 1). Initially, method 300 identifies a record describing a financial transaction associated with a financial institution at 302. Method 300 then accesses metadata associated with the financial transaction from a data source at 304. In some embodiments, this data source is external to the financial institution. Additionally, the metadata accessed from the data source may have a data format and/or data structure that differs from the financial transaction record. If the metadata accessed from the data source has a different data format or data structure, the metadata may be reformatted to be consistent with other metadata handled by the system. In some embodiments, the metadata is accessed from multiple different data sources.

To access the metadata at 304, method 300 accesses social media data associated with the financial transaction at 306 and accesses calendar data associated with the financial transaction at 308. Further, method 300 accesses email data associated with the financial transaction at 310 and accesses geographic location data associated with the financial transaction at 312. Method 300 also accesses event data associated with the financial transaction at 314 and accesses transaction time and date information associated with the financial transaction at 316. Merchant data associated with the financial transaction is accessed at 318. The merchant data includes, for example, merchant contact information, a URL for the merchant's web site, a geographic location associated with the merchant, types of products or services offered by the merchant, and the like.

Method 300 continues at 320 by associating the metadata with the record describing the financial transaction. The association between the metadata and the record describing the financial transaction is stored at 322. In some embodiments, the metadata and the association between the metadata and the record describing the financial transaction are stored in enriched transaction storage device 112 (FIG. 1).

In some embodiments, the transaction enrichment module 102 normalizes the data received from different data sources. For example, the transaction enrichment module 102 may convert the data formats of the received data into a common data format used by all data in the system. Similarly, multiple different terms may be associated with a single term known to transaction enrichment module 102.

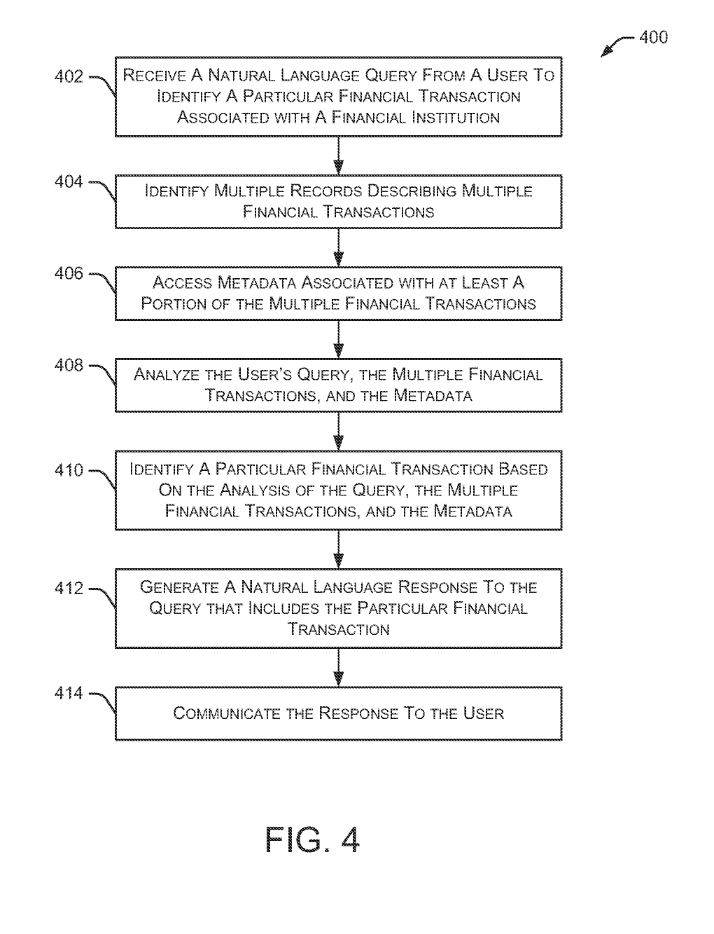

FIG. 4 is a flow diagram depicting an embodiment of a method 400 for processing a user query for a particular financial transaction. In particular implementations, method 400 is performed by transaction enrichment module 102. Initially, method 400 receives a query from a user to identify a particular financial transaction associated with a financial institution at 402. In some embodiments, the user's query is a spoken query presented in a natural language of the user. Method 400 identifies multiple records describing multiple financial transactions at 404 and accesses metadata associated with at least a portion of the multiple financial transactions at 406. Method 400 continues by analyzing the user's query, the multiple financial transactions, and the metadata at 408 to identify a particular financial transaction based on the query, the multiple financial transactions, and the metadata at 410. A response to the user's query is generated at 412 that includes the particular financial transaction. The response is then communicated to the user at 414. In some embodiments, the response is presented to the user in a natural language of the user.

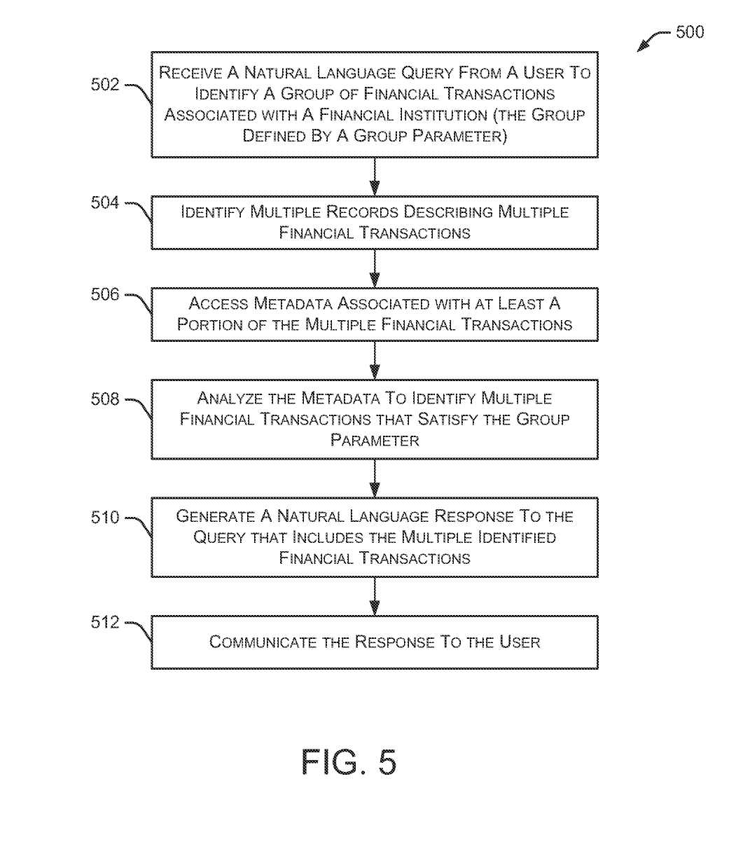

FIG. 5 is a flow diagram depicting an embodiment of a method 500 for processing a user query for a group of financial transactions. In particular implementations, method 500 is performed by transaction enrichment module 102. Initially, method 500 receives a query from a user to identify a group of financial transactions associated with a financial institution at 502. The group of financial transactions is defined by a group parameter. Example group parameters include transactions with a particular date (or range of dates), transactions associated with a particular geographic location, transactions associated with a particular merchant, transactions associated with particular types of merchants, and the like. In some embodiments, the user's query is a spoken query presented in a natural language of the user. Method 500 identifies multiple records describing multiple financial transactions at 504 and accesses metadata associated with at least a portion of the multiple financial transactions at 506. Method 500 analyzes the metadata at 508 to identify multiple financial transactions that satisfy the group parameter. A response to the user's query is generated at 510 that includes the multiple identified financial transactions. In some embodiments, the response to the user's query contains a summary of the identified financial transactions. For example, if the user's query requests the total spent on a particular date, the response to the user's query may provide the total amount spent rather than listing the multiple identified financial transactions. The response is then communicated to the user at 512. In some embodiments, the response is presented to the user in a natural language of the user.

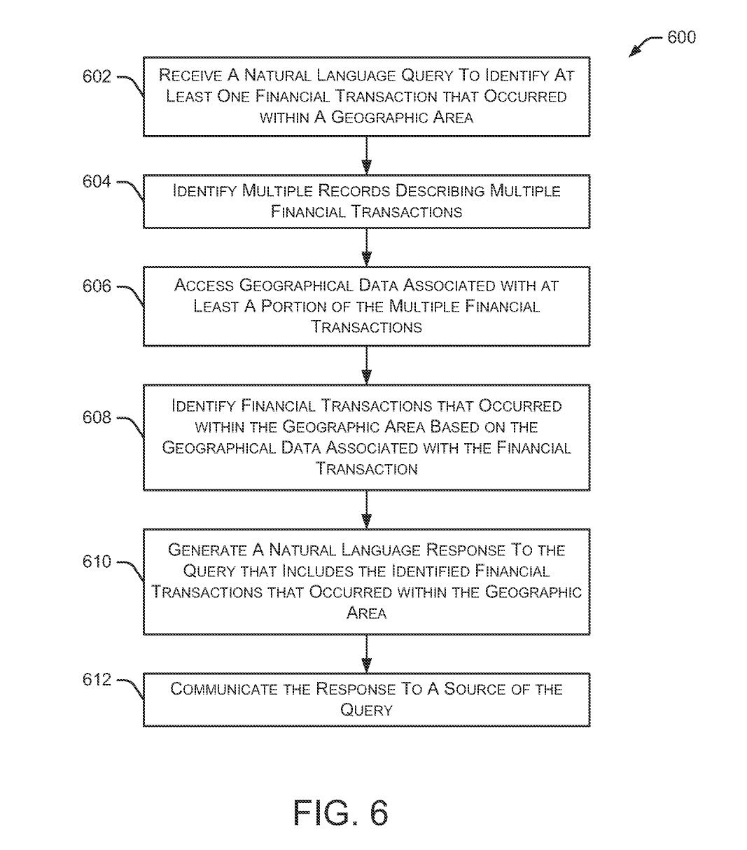

FIG. 6 is a flow diagram depicting an embodiment of a method 600 for geographic clustering of multiple financial transactions. In particular implementations, method 500 is performed by transaction enrichment module 102. Initially, method 600 receives a query from a user to identify at least one financial transaction that occurred within a geographic area at 602. In some embodiments, the user's query is a spoken query presented in a natural language of the user. Method 600 identifies multiple records describing multiple financial transactions at 604 and accesses geographical data associated with at least a portion of the multiple financial transactions at 606. Method 600 continues by identifying financial transactions that occurred within the geographic area based on the geographical data associated with the financial transaction at 608. A response to the user's query is generated at 610 that includes the identified financial transactions that occurred within the geographic area. The response is then communicated to the user at 612. In some embodiments, the response is presented to the user in a natural language of the user.

In another embodiment, multiple financial transactions are grouped together based on known dates for a specific event, such as a business trip or a vacation. In this embodiment, the system may identify the appropriate financial transactions based on the geographic location of the merchant associated with the financial transaction as well as the date(s) associated with the trip. For example, if the business trip was to San Francisco, Calif., from September 7-10, the system identifies transactions with merchants in the San Francisco area between September 7 and 10.

In other embodiments, multiple financial transactions are grouped together based on similar types of products or services, such as “soccer purchases,” “entertainment expenses,” “groceries,” and the like. In these embodiments, the system identifies the appropriate financial transactions based on the geographic location of the merchant associated with the financial transaction as well as the types of products or services sold by the merchant. Additionally, specific financial transactions may have associated metadata that identifies the particular product or service associated with the transaction. For example, if a transaction is associated with a grocery store merchant, that purchase may be associated with a “groceries” group.

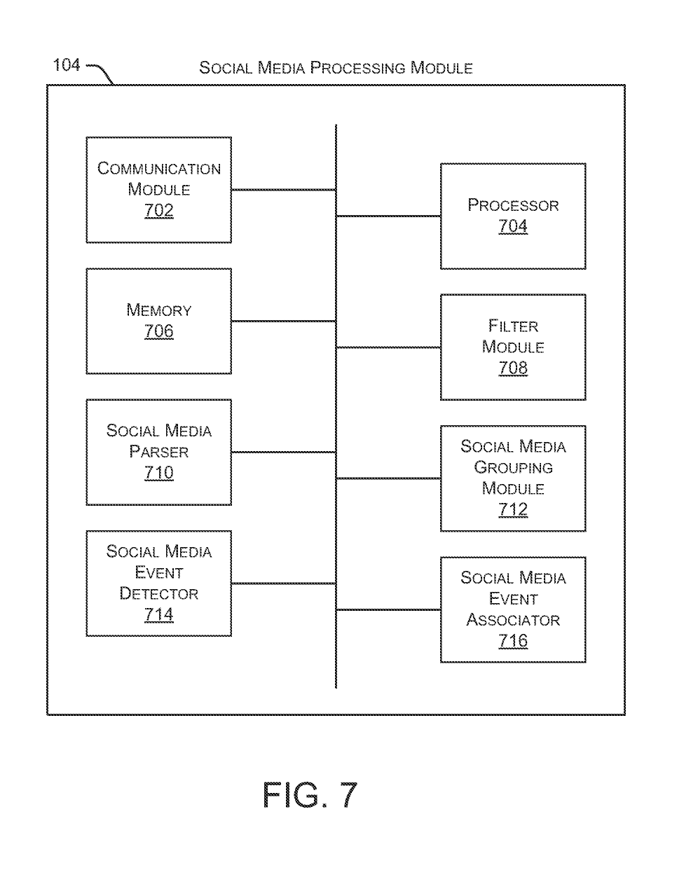

FIG. 7 is a block diagram depicting an embodiment of a social media processing module 104. Social media processing module 104 includes a communication module 702, a processor 704, and a memory 706. Communication module 702 allows social media processing module 104 to communicate with other systems, such as social media sites, external data sources, transaction enrichment module 102, and the like. Processor 704 executes various instructions to implement the functionality provided by social media processing module 104. Memory 706 stores these instructions as well as other data used by processor 704 and other modules contained in social media processing module 104.

Social media processing module 104 also includes a filter module 708 that filters social media data to identify data relevant to particular users or financial transaction data. For example, filter module 708 may identify social media posts and other social media communications associated with the particular user. In some embodiments, filter module 708 filters by subject, sender (e.g., creator of the social media content), and message category. A social media parser 710 transforms social media data into structured data that is consistent with other data managed by transaction enrichment module 102. A social media grouping module 712 classifies social media data received from multiple sources and separates the social media data into groups based on the classification. For example, social media events that occurred at approximately the same time or in the same geographic area can be grouped together. A social media event detector 714 identifies known events that have occurred in one or more social media groups. A social media event associator 716 associates two or more social media events, and may associate known events with newly received social media data.

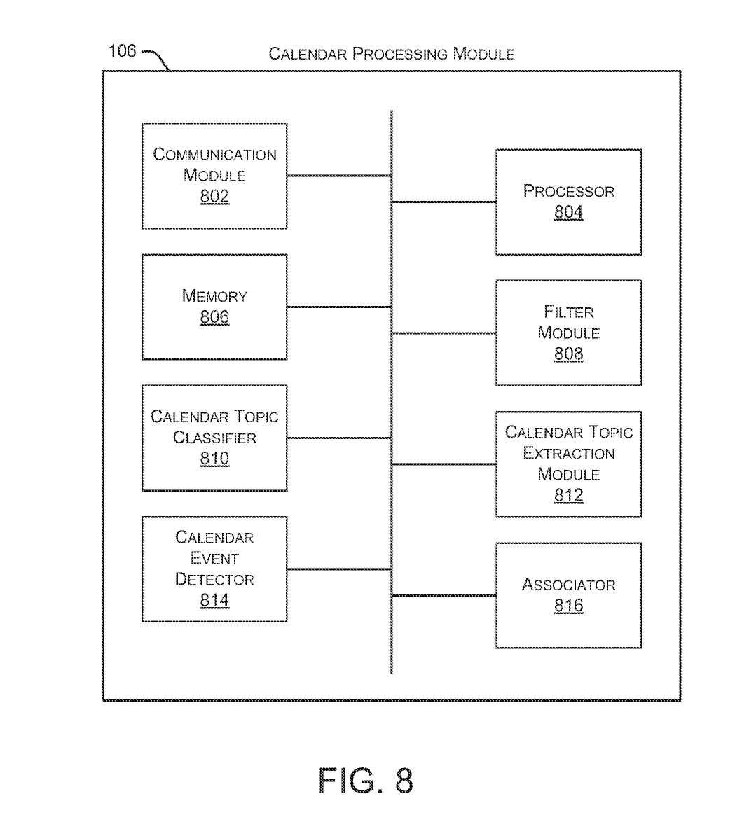

FIG. 8 is a block diagram depicting an embodiment of a calendar processing module 106. Calendar processing module 106 includes a communication module 802, a processor 804, and a memory 806. Communication module 802 allows calendar processing module 106 to communicate with other systems, such as calendar applications, external data sources, transaction enrichment module 102, and the like. Processor 804 executes various instructions to implement the functionality provided by calendar processing module 106. Memory 806 stores these instructions as well as other data used by processor 804 and other modules contained in calendar processing module 106.

Calendar processing module 106 also includes a filter module 808 that filters calendar data to identify data relevant to particular users or specific financial transaction data. For example, filter module 808 may filter calendar data based on a specific date or range of dates. A calendar topic classifier 810 identifies topics associated with various calendar events and communicates relevant events to a calendar topic extraction module 812. Calendar topic extraction module 812 extracts data from calendar events using a combination of extraction rules and statistical classifiers. For example, a calendar entry may contain a comment “meet Bob a Coffee Spot” and a location “5th and Main”. The system will extract those two pieces of information (comment and location) using various grammars and statistical analyzers. A calendar event detector 814 identifies known events and detects relevant event data. In particular, calendar event detector 814 detects calendar events that may contain additional information related to the transactions. For example, the system may learn from the calendar that the user was on vacation during the first week of April. In this situation, all transactions during the first week of April are associated with a “vacation” event. An associator 816 associates calendar events and topics with one or more financial transactions.

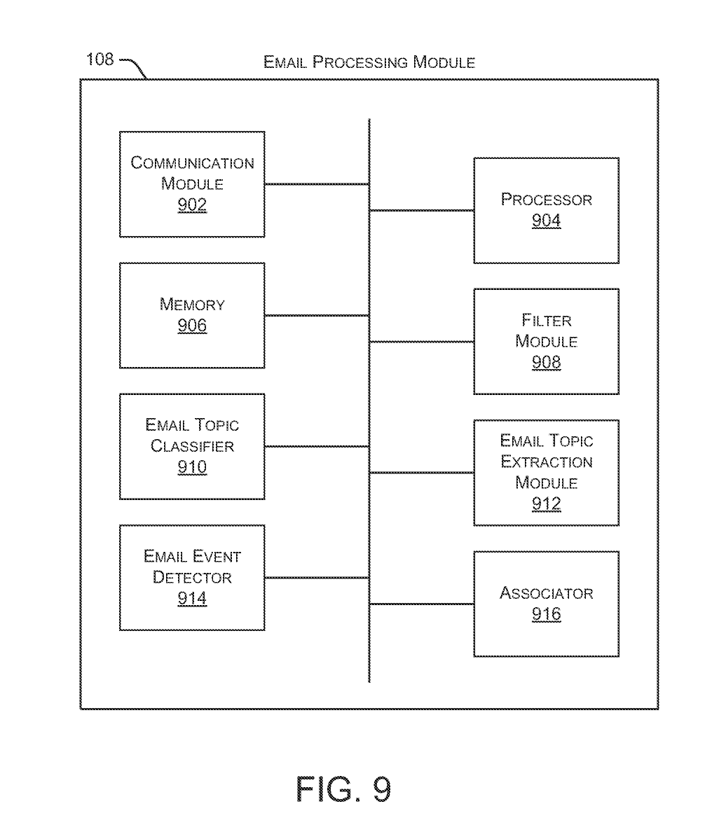

FIG. 9 is a block diagram depicting an embodiment of an email processing module 108. Email processing module 108 includes a communication module 902, a processor 904, and a memory 906. Communication module 902 allows email processing module 108 to communicate with other systems, such as email systems, external data sources, transaction enrichment module 102, and the like. Processor 904 executes various instructions to implement the functionality provided by email processing module 108. Memory 906 stores these instructions as well as other data used by processor 904 and other modules contained in email processing module 108.

Email processing module 108 also includes a filter module 908 that filters email data to identify data relevant to particular users or specific financial transaction data. For example, filter module 908 may filter email data based on a specific user or specific topics discussed in an email message. An email topic classifier 910 identifies topics associated with various email messages and communicates relevant email messages to an email topic extraction module 912. Email topic extraction module 912 extracts data from email data using a combination of extraction rules and statistical classifiers. An email event detector 914 identifies known events and detects relevant event data contained in email messages. An associator 916 associates email data with one or more financial transactions.

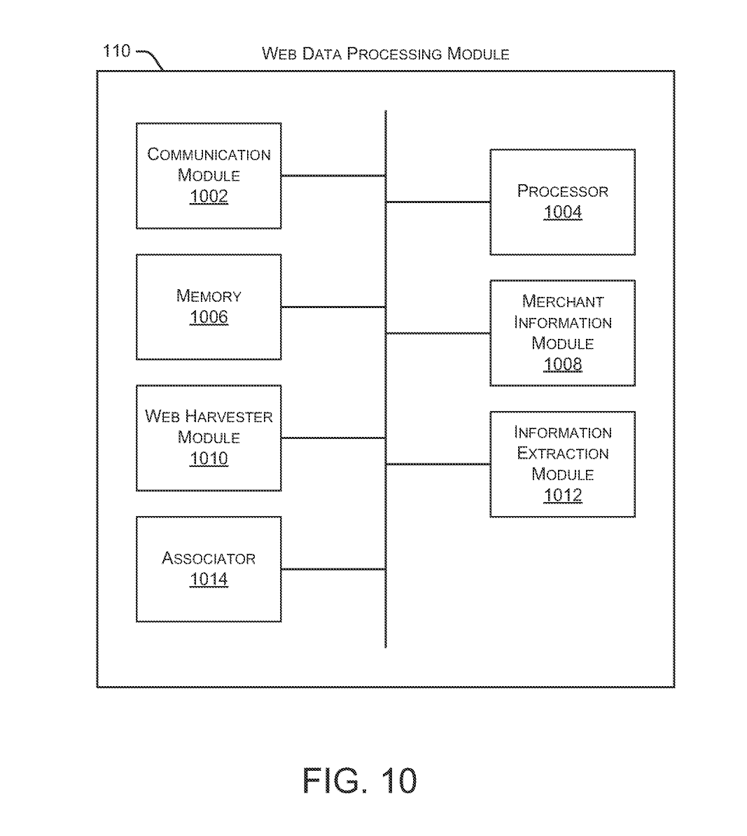

FIG. 10 is a block diagram depicting an embodiment of a web data processing module 110. Web data processing module 110 includes a communication module 1002, a processor 1004, and a memory 1006. Communication module 1002 allows web data processing module 110 to communicate with other systems, such as web sites, external data sources, transaction enrichment module 102, and the like. Processor 1004 executes various instructions to implement the functionality provided by web data processing module 110. Memory 1006 stores these instructions as well as other data used by processor 1004 and other modules contained in web data processing module 110.

Web data processing module 110 also includes a merchant information module 1008 that searches multiple data provider services for information relevant to financial transactions (e.g., merchant information). A web harvester module 1010 harvests merchant information (and other data) from data retrieved from web sites, external data sources, and the like. An information extraction module 1012 extracts relevant information harvested from one or more web sites or other data sources. In some embodiments, information extraction module 1012 uses templates and statistical entity processors to extract relevant data. For example, a template processor may use rules to find information, such as <x> bought <y> shares of <z> on <date> related to a stock purchase. Various statistical processors learn how to extract the data from analyzing multiple example transactions. An associator 1014 associates retrieved web data, such as merchant data, with one or more financial transactions.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A method comprising:
identifying a financial transaction record that describes a financial transaction associated with a financial institution;
accessing, using one or more processors, metadata having a relationship to the financial transaction from a data source external to the financial institution, wherein the metadata is not structured as a financial transaction record;
associating the metadata with the financial transaction record; and
storing the association between the metadata and the financial transaction record.

2. The method of claim 1, further comprising defining, using the one or more processors, an event based on the metadata associated with the financial transaction.

3. The method of claim 2, further comprising:
identifying a second financial transaction having similar associated metadata; and
associating the second financial transaction with the event.

4. The method of claim 1, wherein the metadata includes at least one of social media data, calendar data, email data, geographic location data, event data, transaction time data, transaction date data, and merchant data.

5. The method of claim 1, wherein the accessing metadata includes accessing social media data from a social media processing module.

6. The method of claim 1, wherein the accessing metadata includes accessing calendar data from a calendar processing module.

7. The method of claim 1, wherein the accessing metadata includes accessing email data from an email processing module.

8. The method of claim 1, wherein the accessing metadata includes:
accessing social media data associated with the financial transaction;
accessing calendar data associated with the financial transaction;
accessing email data associated with the financial transaction; and
accessing merchant data associated with the financial transaction.

9. The method of claim 1, further comprising reformatting the metadata structure prior to associating the metadata with the financial transaction record.

10. A method of claim 1, further comprising:
receiving a query from a user to identify a particular financial transaction associated with the financial institution;
identifying a plurality of financial transaction records;
accessing metadata associated with at least a portion of the plurality of financial transaction records; and
analyzing the query and the metadata to identify the particular financial transaction.

11. The method of claim 10, further comprising:
generating a natural language response to the query that identifies the particular financial transaction; and
communicating the response to the user.

12. The method of claim 10, wherein the query is a natural language query.

13. The method of claim 1, further comprising:
identifying a transaction date in the metadata associated with the financial transaction record;
accessing transaction date data associated with a plurality of financial transactions of the financial institution; and
identifying additional financial transactions having transaction dates that match the date in the metadata associated with the financial transaction record.

14. The method of claim 13, further comprising creating a transaction group that includes the financial transactions having transaction dates that match the date in the metadata associated with the financial transaction record.

15. The method of claim 1, further comprising:
identifying merchant data in the metadata associated with the financial transaction record;
accessing merchant data associated with a plurality of financial transactions of the financial institution; and
identifying additional financial transactions having merchant data that matches the merchant data in the metadata associated with the financial transaction record.

16. The method of claim 15, wherein the merchant data includes at least one of a merchant name, a merchant location, a merchant address, a merchant phone number, and a merchant web site.

17. The method of claim 15, further comprising creating a transaction group that includes the financial transactions having merchant data that matches the merchant data in the metadata associated with the financial transaction record.

18. A method comprising:
receiving a query to identify financial transactions that occurred within a geographic area;
identifying a plurality of financial transaction records;
accessing, using one or more processors, metadata associated with the plurality of financial transaction records, wherein the metadata is not structured as a financial transaction record;
analyzing, using the one or more processors, the metadata associated with the plurality of financial transaction records to identify at least one financial transaction that occurred within the geographic area; and
generating a response to the query that identifies the at least one financial transaction that occurred within the geographic area.

19. The method of claim 18, wherein the query is a natural language query.

20. An apparatus comprising:
a memory to store data associated with a plurality of financial transactions; and
one or more processors coupled to the memory, the one or more processors configured to:
identify a financial transaction record that describes a financial transaction associated with a financial institution;
access metadata having a relationship to the financial transaction from a data source external to the financial institution, wherein the metadata is not structured as a financial transaction record;
associate the metadata with the financial transaction record; and
record the association between the metadata and the financial transaction record.
